(19) United States
(12) Patent Application Publication
(10) Pub. No.: US 2026/0116689 A1
(43) Pub. Date: Apr. 30, 2026

(54) A FLEXIBLE MATERIAL ROLLING MACHINE

(71) Applicant: LOOP TECHNOLOGY LTD, Dorset (GB)

(72) Inventors: Timothy Matthew GARTON, Dorset (GB); Ian David REDMAN, Dorset (GB); Nathan Samuel Bayliss GRIST, Dorset (GB); Joel EDWARDS, Dorset (GB); James Champion STREATFEILD, Dorset (GB)

(21) Appl. No.: 19/472,703

(22) PCT Filed: Apr. 5, 2024
(86) PCT No.: PCT/IB2024/053357

§ 371 Date: Oct. 5, 2025

(30) Foreign Application Priority Data
Apr. 5, 2023 (GB) 2305101.4

(51) Int. Cl. B65H 18/10; B65H 23/195; B65H 29/00

(52) U.S. Cl. CPC B65H 18/103; B65H 23/1955; B65H 29/006; B65H 2404/1452

(57) ABSTRACT

A machine comprises a pick and place stage and includes a plurality of releasable connectors.

A support material is wound over rollers onto a storage roller or spool. The backing support material provides a substantially flat surface upon which a sheet of flexible material is placed by the pick and place stage.

The sheet of material and the backing support material are then wound onto the storage roller or spool which may be removed for storage and/or transportation.

Delicate sheets of pieces of flat material, such as carbon fibre, may thus be protected from damage during handling, storage and transportation that may otherwise result in damage to the material.

The process is reversed to lay down the material, for example into a mould, during manufacture of, for example, an aeroplane wing.

### FIELD

The invention relates to a flexible material rolling machine.

More particularly, but not exclusively, the invention relates to a flexible material rolling machine arranged to pick up, move, store, place and retrieve a piece of flexible material.

More particularly, but not exclusively the invention relates to a flexible material rolling machine arranged to pick up, move, store, place and retrieve a piece of flexible material while protecting the piece of flexible material. The term piece of flexible material includes woven sheets and non-woven sheets of material.

### BACKGROUND

Within the aerospace industry, several new aircraft have entered production that use large-scale carbon fibre elements in their construction, especially in the wings. Typically, these carbon fibre elements are supplied in a flexible, sheet form and allows for the provision of lighter wing structures than conventional wing structures while maintaining the strength needed.

To ensure the integrity of the components in new generation of airliners, it is imperative that the carbon fibre materials, used in wing construction, is not subject to any activity that may compromise the structural integrity of the carbon fibre materials, for example by creasing, stretching, crushing, tearing, or otherwise permanently deforming them.

Large sheets of material are used to build components and handling these sheets of material can result in damage. Therefore, a process of rolling the material, including raw material supplied from a manufacturer, are used to transport material between assembly lines or even within factories.

The process of rolling is also problematic and if not carried out with utmost care, can result in substandard material whose integrity is compromised.

Due to the high cost of the material, it is also important to limit waste. Therefore, the material is cut to exact dimensions prior to being assembled onto mould tools. When placed on tooling or on mould tools, extremely accurate placement is required to ensure full coverage of the component area to maintain high quality requirements and minimise waste.

A further challenge is to meet the required number of components to satisfy a supply chain, and to achieve this, an improvement in manufacturing time is required. Therefore, a process that allows large areas of bulk flexible material to be deposited quickly, carefully, and accurately is required.

### PRIOR ART

An example of a flexible material rolling machine is disclosed in published international patent application number WO 2019/123209 (Loop Technology limited) which discloses a system for handling sheets of flexible material.

The system comprises a first roller which has a plurality of first releasable connectors and a second roller which has a plurality of second releasable connectors.

An array of third releasable connectors is displaceable between at least the first and second rollers. The first, second and third releasable connectors releasably attach to a sheet of flexible material in use.

Although successful, the aforementioned flexible material rolling machine disclosed is rather complex with a high operating cost, is limited to handling relatively simple material shapes, only one piece of material at a time, with a limited process speed.

Further objects of the invention are to provide a flexible material rolling machine which protects the material during a picking stage, a rolling stage, a placing stage, when rolled for long term storage, as well as improving placement accuracy and process speeds.

UK patent application number GB 2 568 767 (Loop Technology limited) discloses a system for handling sheets of flexible material. The present invention arose to solve the aforementioned problems of, only a single piece of material can be moved/stored at one time, the complexity and operating cost of system, the relatively simple material shapes that maybe processed and the slow process speeds associated with the aforementioned flexible material rolling machine.

An aim of the present invention is therefore to provide a system for handling sheets of material which facilitates their storage and avoids damage to the sheets and reduces damage to the sheets during manufacture of complex components.

Another aim of the present invention is to provide a machine for picking up, moving/storing and placing sheets of flexible material which avoids material damage, reduces material waste, improves placement accuracy, and decreases manufacturing time.

### SUMMARY OF THE INVENTION

According to a first aspect of the invention there is provided a flexible material rolling machine comprising: a drive means which is operative to drive a first material storage spool or roller and a supply of a flexible support layer which is wound onto the first material storage roller or spool when the drive means is operational; an area of the flexible support layer receives and supports a sheet of flexible material to be rolled, whereby the sheet of flexible material is sandwiched between the flexible support layer, on which it is supported, and an underside of the flexible support layer that is already wound on the first material storage roller or spool.

In some embodiments the first material storage roller or spool is cylindrical. Other shaped spools are envisaged, for example spools with oval or prismatic cross-sections.

However, the storage roller or spool may also be oval, or a closed shape bounded with straight sides in cross-section. In some embodiments, the first material storage roller or spool maybe made up of a number of hollow drums, rollers or elements onto which the flexible material is wrapped or wound.

Preferably the supply of the flexible support layer is provided by a second storage roller or spool.

Ideally at least one drive means is provided for driving the second storage roller or spool. In some embodiments the drive means is performed by the first drive means.

The, or each, material storage roller or spool may be removed from the machine to allow the flexible material to be transported either within a factory, from a preparation area to a final placement area, or from a manufacturer to a customer for example.

Further embodiments may contain additional functionality such as a material control stage for controlling a physical characteristic of the flexible material as it is loaded/unloaded into the storage stage, including but not limited to tensioning, debulking, cutting, inspection, motion and positional control.

An advantage of the invention is that it provides a system for picking, storing and accurate placement of a wide range of sizes of fabric with the option of material manipulation where appropriate. The flexible material or material fabric is sandwiched between the flexible support layer, around the effective roller circumference, between previously wound flexible support layer, and therefore the fabric is trapped to resist movement and protected from damaged during the winding process due to minimal and careful material interaction. The system also enables multiple sheets of flexible material to be processed at one time.

Another advantage of the invention is that implementation of a backing support material significantly improves material support on the storage roller. Loose edges of flexible material or fabric are prevented from flapping or being creased when rolled or spiralling or bulking during rotation of the storage roller or spool. This significantly reduces damage to the fabric.

Another option is to provide an intermediate protection layer between flexible sheets and the support surface which may be used to reduce friction, pinching and scuffing between adjacent sheets or layers of material.

A further advantage of the backing support material is that it also limits slippage of the material during rolling of the material onto the storage roller.

The backing support material also restrains the flexible material and prevents it from moving during storage and during removal (unloading) of the flexible material. This advantage also applies to the unrolling of the material when it comes to be laid out in manufacturing (for example in a mould). Consequently, when the fabric comes to be laid down, the location of material features, such as the leading edge, is known precisely and is repeatable for the material placement process.

It is also possible to store multiple pieces of material onto a single storage roller. Existing systems can only pick and store one piece of material regardless of size. Use of the backing support material allows a user to pick as many pieces as necessary. This has a further advantage that, when the fabric is unrolled, the multiple pieces of fabric are provided in a particular order, predetermined by the rolling process.

Further advantages of the invention are described below.

There is improved material leading edge handling/control and material placement accuracy using an intelligent pick/place stage. During placement, the pick/place stage utilises a plurality of releasable connectors to pick the material from a surface, which may be within a machine, and then accurately to place the material onto a final placement surface. Movement and activation of each of the plurality of releasable connectors during the pick/place stage, maybe individually controlled to manage complex material shapes and leading edges as well as to define a final placement surface form and to control material integrity and placement accuracy.

As a consequence of the invention there is a significantly lower compressed air requirement, due to efficiency of the method and this in turn reduces cost because the number of releasable connectors which are deployed is reduced. In some embodiments electrically powered connectors may be used, such as motorised connectors and/or connectors powered by one or more fans and/or electrostatic devices.

The invention enables material deposition rates to be faster, more efficient, and so production and unit costs are reduced, because the pick place process carried out has been simplified significantly. Multiple pieces of fabric may also be rolled up and moved/stored effectively in one process.

The system weighs less and results in a reduced load capacity requirement for the deployment system, such as a robotic actuator and consequently less control devices are required. In one embodiment the flexible material rolling machine may be robot mounted, for example on a robotic manipulator. Preferably the operation of the flexible material rolling machine is synchronised with motion of the robotic manipulator motion.

Another advantage is there is reduced system complexity and cost.

According to another aspect of the invention there is provided a method of operating a flexible material rolling machine comprising the steps of: operating a drive means to drive a first storage spool or roller; operating a second storage spool or roller which has a flexible support layer wound thereon, unwinding the flexible support layer from the second storage spool or roller and winding the flexible layer onto the first storage spool or roller when the drive means is operational; deploying an area of the flexible support layer and supporting a sheet of flexible material to be rolled, on a support surface thereof; and sandwiching the sheet of flexible material between an underside of the flexible support layer, that is already wound on the first storage spool or roller and the support surface of the flexible support layer.

According to a yet further aspect of the invention there is provided a material storage spool or roller has a flexible support layer wound thereon, a portion of an area of the flexible support layer is in contact with a sheet of flexible material that is sandwiched between the flexible support layer, on which the sheet of flexible material is supported, and an underside of the flexible support layer that is wound on the first material storage roller or spool.

A further advantage is that with the addition of cutting elements, there is the capability of continuous material feed using bulk material. For large area requirements, a full roll of bulk/uncut material can be loaded onto the machine and accurately placed onto a surface.

### BRIEF DESCRIPTION OF THE FIGURES

The present invention will now be described by way of example, with reference to the drawings, in which:

FIG. 1 shows a side elevation of a first embodiment of the present invention;

FIG. 2 is a perspective view of the first embodiment;

FIG. 3 shows the first embodiment of the present invention with the material handling stage in a retracted position;

FIG. 4 shows a side elevation of a second embodiment of the present invention with a recirculating material handling stage;

FIG. 5 shows a perspective view of the second embodiment;

FIG. 6 shows a fourth embodiment of the present invention;

FIG. 7 is a side view of the fourth embodiment;

FIG. 8 is a diagram showing the present invention prior to material being wound or stored;

FIG. 9 is a diagram showing the present invention with material loaded into a storage stage;

FIG. 10 is a diagram showing three stages of the present invention, a material handling stage, a material transfer stage, a control stage and a material storage stage;

FIG. 11A is a diagram of the present invention showing the process of the material handling stage picking the flexible material and transitioning from a pick/place surface to the material transfer stage;

FIG. 11B is a diagram of the present invention showing the process of the material handling stage picking the flexible material; and

FIG. 11C is a diagram of the present invention showing the process of the material handling stage-transitioning over to the material transfer stage.

### DETAILED DESCRIPTION OF EMBODIMENTS OF THE INVENTION

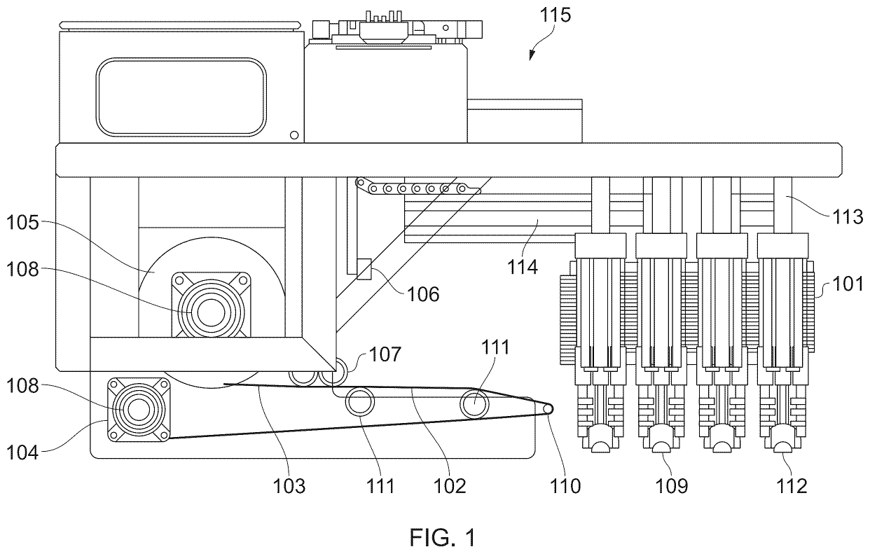

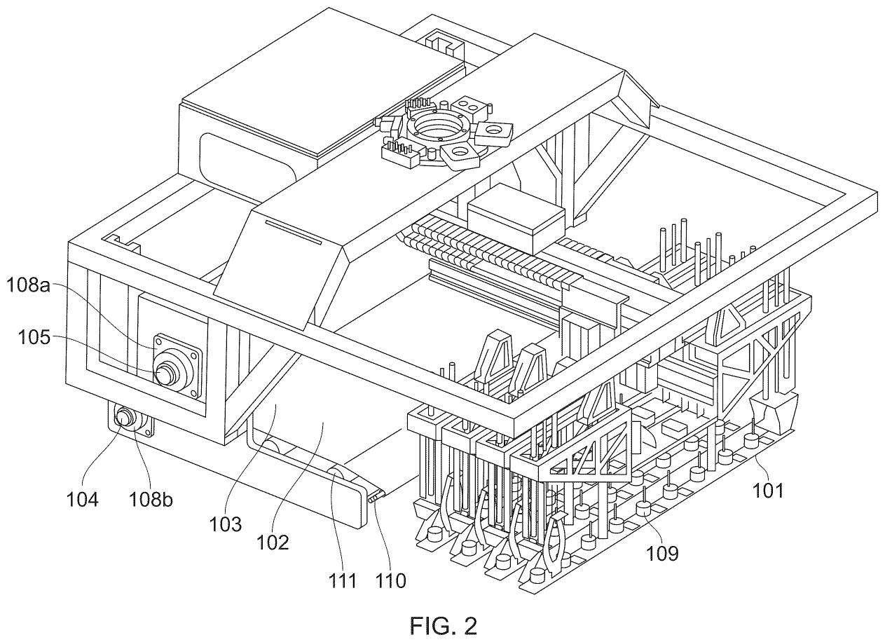

In overview, FIG. 1 shows a side elevation of a system for handling varying sizes of flexible material, such as a fabric or flexible sheet of material 1101. A flexible support layer 103 is wound off a backing support material storage roller 104 and reversed in direction at a leading edge roller 110 before the flexible support layer 103 is wound onto a first material storage roller 105. Between conveyor leading edge roller 110 and the first material storage roller 105, the flexible support layer 103 presents a substantially flat surface 102, supported by a conveyor support system 111. A material handling stage 101 picks the fabric or flexible material 1101 from a surface and places it on top of the support layer 103.

Rotation of the first material storage roller 105 and backing support material storage roller 104 commences and the support layer 103 and fabric 1101 are drawn onto the first material storage roller 105 together. The fabric 1101 is thus sandwiched between the portion of support layer 103 upon which it was placed and the first material storage roller 105 or a portion of the support layer 103 that was already wound on the storage roller.

The system comprises a material handling stage 101, also known as a pick/place stage, a material transfer stage 1202 and a storage stage 1203.

The material handling stage 101 (pick/place stage) comprises an array of releasable connectors 112 that define a mechanism to either pick material from a preparation surface 1302, in order to place it on to the transfer stage 1202, or to pick material from the transfer stage 1202 and place it onto a preparation surface 1302.

Material stabilisation units 109 are used to bond material layers together once placed onto the final placement surface, in order to stabilise/fix the position of the placed material.

FIG. 1 shows the material handling stage 101 in a first position in which a piece of fabric may be picked up, for example from a preparation surface 1302 or cutting table, ready for rolling. The releasable connectors may be, as shown here, suction cups that suck the fabric upwards. However, they may equally comprise vacuum connectors, needle connectors, cryogenic connectors, electromagnetic connectors or electrostatic connectors. The connectors are preferably independently controllable and independently positionable with respect one to another.

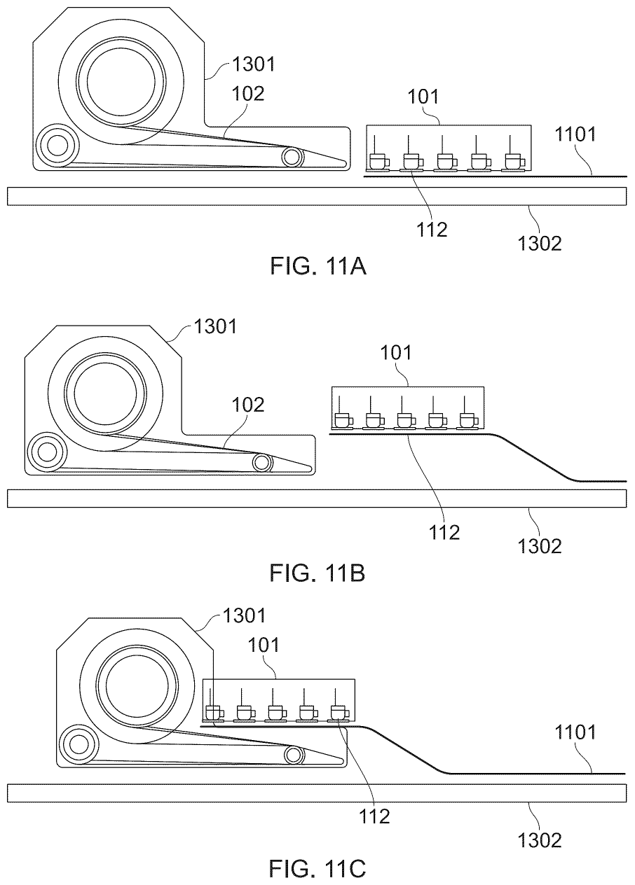

FIGS. 11A, 11B and 11C show an example of operation, where releasable connectors 112 are lowered by a releasable connector raising/lowering control mechanism 113 and are activated to attach to the piece of fabric 1101 to be rolled which is typically supported on a preparation surface 1302 such as a cutting table. The releasable connectors 112 are preferably arranged to be individually controllable so that only the appropriate connectors are activated for a particular piece of material. The raising/lowering mechanism 113 is then activated to raise the piece of fabric 1101 upwards.

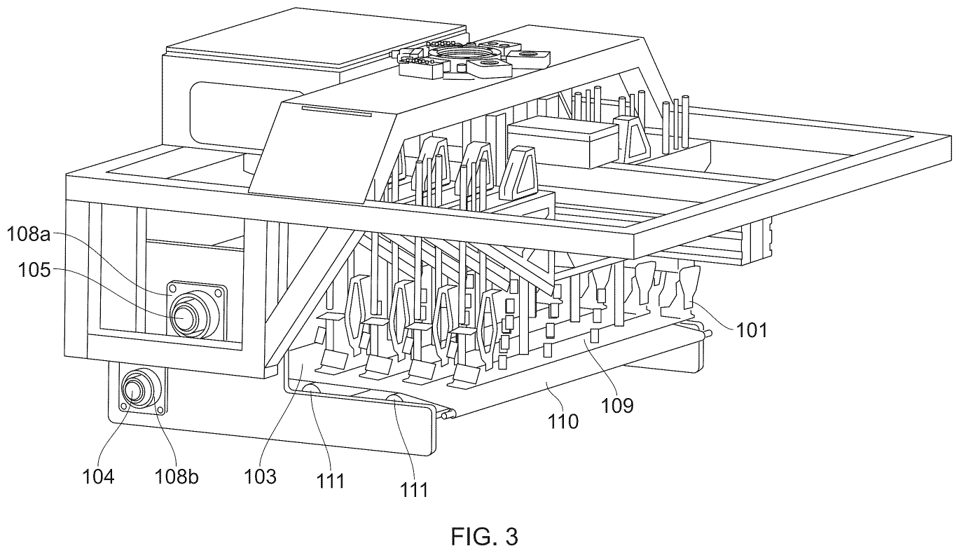

A material handling transfer and control mechanism 114 (which may include a robot) is then activated to move the entire material handling stage to a second position above the material transfer stage 1202 and material support layer 103. FIG. 3 shows the material handling stage 101 in this second position. The raising/lowering mechanism 113 is then activated to lower the piece of material or fabric 1101 onto the material conveyor 102 includes a support layer and the releasable connectors are deactivated. The piece of material and the material support layer are then ready to be rolled.

Means may be provided in the material handling stage (also referred to as a pick/place stage) to vary at least one of the orientation and/or location of the releasable connectors whilst attached to a sheet of fabric material so as to deform the sheet to a new shape. This is generally done when the piece of material is removed from the storage roller as part of the place phase, rather than during the storage phase, unless the system is picking from a non-flat surface.

Although a rectilinear array of connectors is shown, different arrangements of connectors may be utilised for different applications. While an array of releasable connectors that maybe moved between a first and second position are shown, they may alternatively be provided in a continuous recirculating feed.

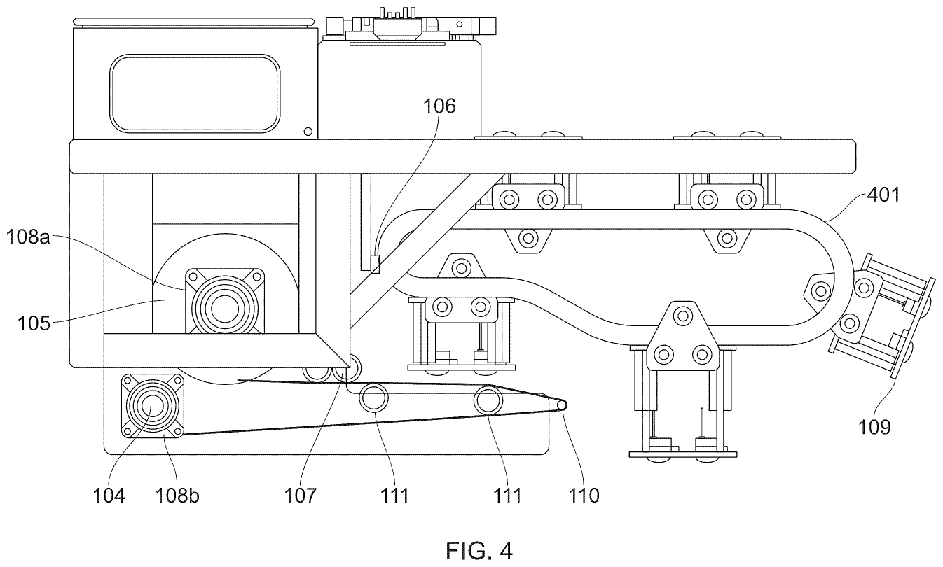

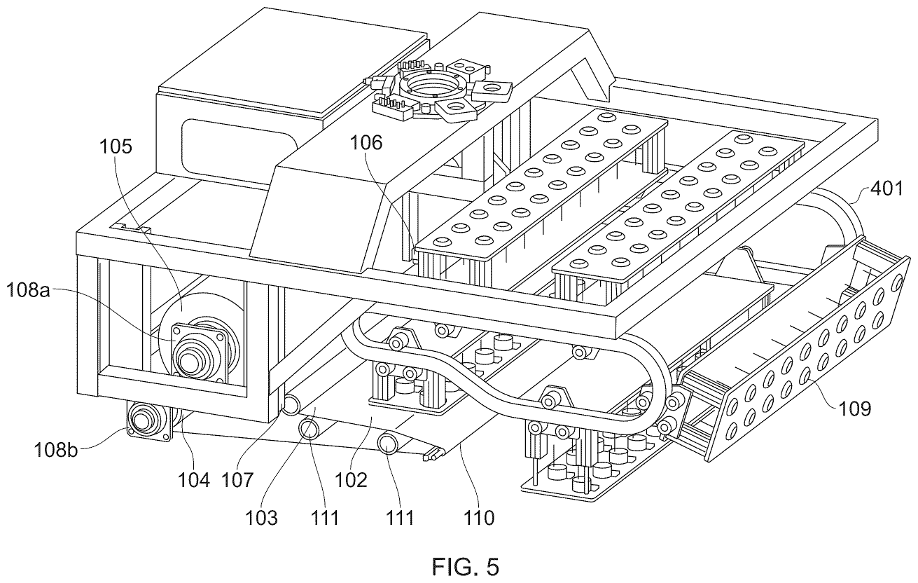

A continuous feed mechanism (as shown in FIGS. 4 and 5) may include a walk beam (not shown) type arrangement, whereby a stepped feed is implemented as either a ‘sequential movement and pause’ using one linear feed action, or as linked stepped linear feed sets, so that the motion is continuous due to one set of linear actuators advancing through the feed stoke, whilst the other feed set(s) move towards the start of a feed stroke type arrangement to provide continuous loading/unloading from planar to planar or double curvature formation. Alternatively, a recirculating track (FIGS. 4 and 5) or wheel provides continuous recirculation of forming splines and associated releasable connectors transitioning between being tangential to the storage load/in-load plane and tangential to the application surface.

Optionally tacking or other such means of material (ply) stabilisation may be employed at the point of or shortly thereafter placement.

The material transfer stage includes a material conveyor 102 which moves the combination of support layer and fabric towards the first material storage roller 105. The first material storage roller 105 is driven by a motor (not shown) such as a stepper or a servo motor 108a. In an embodiment in which pieces of fabric are recovered from the storage roller, the support material storage roller is also driven by a motor 108b.

Control of the first material storage roller 105 and the backing support material storage roller 104 is carried out by roller controllers 108a and 108b. Whether the apparatus is being used to store or recover pieces of material, the flexible support layer effectively creates a conveyor belt (or similar) arranged between rollers 104, 110 and 105 and supported by a conveyor support system, 111.

Optionally a solid sheet may be deployed to support the material rather than relying on the rollers. A solid sheet backing support may be used to improve backing support material (conveyor) stability and associated ply stability and positional accuracy. The solid sheet backing support may be a roller bed or sheet of rigid or semi-rigid backing material. However, if the span between rollers is small or flexible backing support material tension is high, or if there is an application specific benefit, then a solid sheet backing support structure may not be required.

Tension in the material support layer may be measured by a sensor (not shown) on a tensioning dancer (not shown), or alternatively a sensor that monitors an output current of one, or both motors 108a and 108b which provide drive means to the roller. By using characterising motors in this way, the output torque can be determined as a function of motor phase current and shaft speed. Measurement of the motor winding current may also be used to provide a value for the output torque of the motor, and hence torque applied to the roller and therefore tension that is applied to the material support layer may be derived and controlled.

Material support layer tension may be controlled via a tensioning dancer or by adjusting the relative position between the first material support roller and subsequent rollers. A proportional-integral-derivate (PID) controller maybe used to achieve a target set point torque on one of the spool rollers. This controller may then oversee and control movement of the roller to take up any slack to achieve a required tension.

Optionally one of the rollers is continuously controlled to a position setpoint. The control of the roller may be a programmed motion profile or movement which is synchronised with an external device, such as a robotic arm, or cutting table.

By synchronising the position and velocity of a roller to an external device, pick or place operations of flexible material may be synchronised between the rolling machine and external surfaces. The flexible material is thus able to be loaded or unloaded on (or off) a roller (rolling machine) with minimal slippage on either the roller (rolling machine) or the external surface.

Pinch/grip rollers together define a material control stage 107 and are provided to control the progress of material onto the first material storage roller 105.

In alternative embodiments the pinch/grip rollers may be material bulk control or a material debulking solution.

Material (ply) stability at the point of or shortly thereafter placement onto the machine could be supplemented by a material support system to ensure that the fabric and the support layer do not suffer any relative movement before they are wound onto the storage roller. Such a material support system may comprise a mechanical arrangement, or a vacuum or pressurised air arrangement to maintain material positioning during transfer.

In some embodiments the storage rollers are removable and replaceable and suitable quick release means may be provided to facilitate this. This feature enables rollers to be removed for storage or replacement or repair.

Additional functionality can be employed, depending on the complexity of the desired process, such as material cutting, debulking, material manipulation and tacking. An optional cutting stage, such as the material control stage 107, (shown in FIG. 1), may be provided.

As the fabric is rolled onto or off the machine, a cutting method, such as a roller knife or ultrasonic knife, can be used to cut the material into the desired final shape. Waste material can be collected by a hopper, such as the dynamic pick place stage and disposed of during the process.

A viewing, vision stage or imaging system 106 is provided to monitor movement of the fabric and detect details in the material such as edges or defects. The viewing, vision stage or imaging system 106 can also be used to monitor features, such as monitoring of the leading edge of the fabric to increase pick/place accuracy. The vision stage or imaging system 106 may also be utilised to monitor the backing support material for proactive maintenance planning purposes. Further sensors within the machine can report sub assembly or component status to also enable proactive maintenance planning. The vision stage is coupled to a controller 115 to implement corrective action and/or sound an alarm if an item, sheet of material or piece of fabric is determined to be misplaced or damaged.

An imaging system may comprise one or more camera devices which have visibility over at least a portion of a sheet or layer of backing material. Each camera may be operative continuously or operative to capture single images on demand, such as in response to a sensor or timer. Cameras may be industrial vision devices featuring a global shutter.

An image analysis algorithm may use the images to detect the position and orientation of flexible material as it is loaded or unloaded.

Recording locations of flexible material within the rolling machine may also be specified to optimise speed of location and recovery of a stored sheet of material or item from a storage roll on a subsequent occasion.

A controller may record the position and orientation of all pieces of flexible material loaded into the rolling machine.

The third, storage, stage includes the first material roller 105 to store the material in use. The roller or spool utilises a backing or support material to aid rolling, support, and storage of the material. The flexible support material or backing support material can be used as part of the transfer mechanism. The storage roller or spool maybe detached from the system to enable longer term storage (that is anything longer than immediate re-use) options of the material in use.

The storage system is designed to not limit the length of fabric to be stored although the maximum size of the storage roller does place an implicit limit.

Once the leading edge of a fabric being loaded has been transferred onto the flexible backing support material then feed onto the storage roller or spool may begin and continue until to storage capacity limits of the storage roller are reached. The storage roller size maybe designed to suit the length required using a common design architecture and following all of the same, previously discussed principles.

Additional leading edges or other such features that may require transfer onto the stage loading surface may require pick and place, but this does not require continuously recirculating transfer connections unless the pitch between features presents a limit to transfer or speed and continuity of transfer requires multiple edges or other such features to be simultaneously handled.

The three stages maybe operated independently or combined depending on the complexity of the operation.

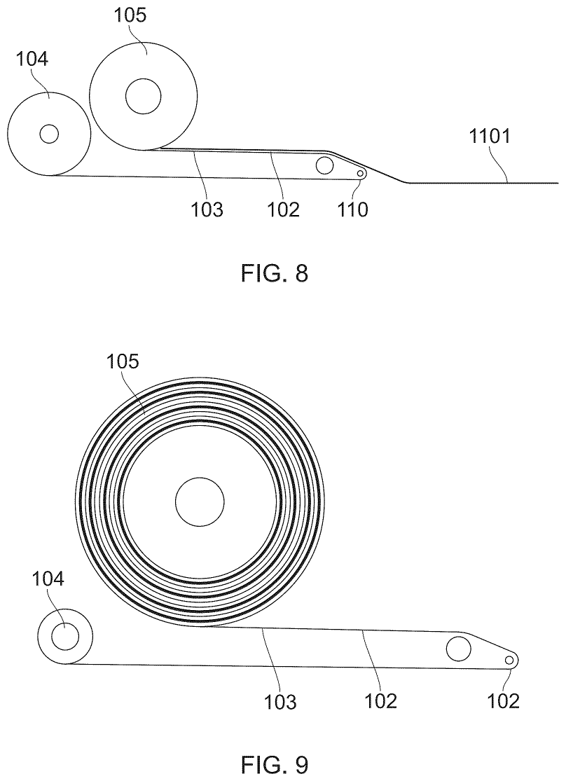

An example of the system in operation will now be described with reference to FIGS. 8 and 9 and 11A, 11B and 11C.

A sheet of flexible material 1101 is picked and placed in a manner which reduces distortions and creases. For simple high radius curvatures, gravitation deposition onto the final placement surface has been found to be sufficient. However, lower radius curvature or features with complex curves or small radii of curvature tend to require greater control when depositing the material. In these instances, active formation of a deposited ply may be beneficial.

The material handling stage 101 may be a rigid rectilinear construction, as shown in FIGS. 4 and 5, or a conformal material handling stage 101, to control transfer between planar presentation from the material handling stage 1202 to a complex form such as double curvature to match the final placement surface.

As shown in FIG. 11A, a flexible material rolling machine 1301 is located above a preparation surface 1302. The material handling stage 1101 selects and lifts a sheet of flexible material 1101. A vision stage or imaging system (not shown) may be used to monitor the sheet of material 1101, its location and integrity while the sheet of material is on the preparation surface 1302. The material handling stage 101 lifts the flexible material 1101, utilising the releasable connectors 112, away from the preparation surface 1302, which may be a cutting table.

Referring briefly to FIGS. 8 and 9, the flexible material 1101 is then positioned over the material transfer stage 1202 of the material rolling machine 1301. The material handling stage 101 then lowers and releases the flexible material 1101 onto a transfer stage 1202. The flexible material 1101 is then supported by the material transfer stage 1202 and its associated mechanisms, as it moves towards an interaction point with the first material storage roller 105 in the material support and storage stage 1203. The flexible material 1101, now supported by the flexible support layer 103, is then rolled around the first material storage roller 105.

It is understood that the process may also be carried out in reverse to accurately place the material 1101 onto the final placement surface, such as a mould or layup tool.

It is also to be appreciated that the term ‘flexible support layer’ is herein referred to as a ‘backing support material’.

Depending on the process requirements further stages maybe used. For example, a vision stage or imaging system 106 (FIG. 1) and material control stage 107 (FIG. 1) may be used to track and control material features to improve pick/place accuracy, material cutting and waste collection, and material debulking. Likewise, some stages may be removed, such as the material handling stage 101, as the process dictates. In the embodiment shown in FIGS. 8 and 9 the flexible material 1101 is loaded onto the material transfer stage 1202 by an external system, and then simply dropped onto the final placement surface.

The material handling stage 101 may also be operated separately to the main machine to load/unload flexible material onto this machine or in another process depending on the application.

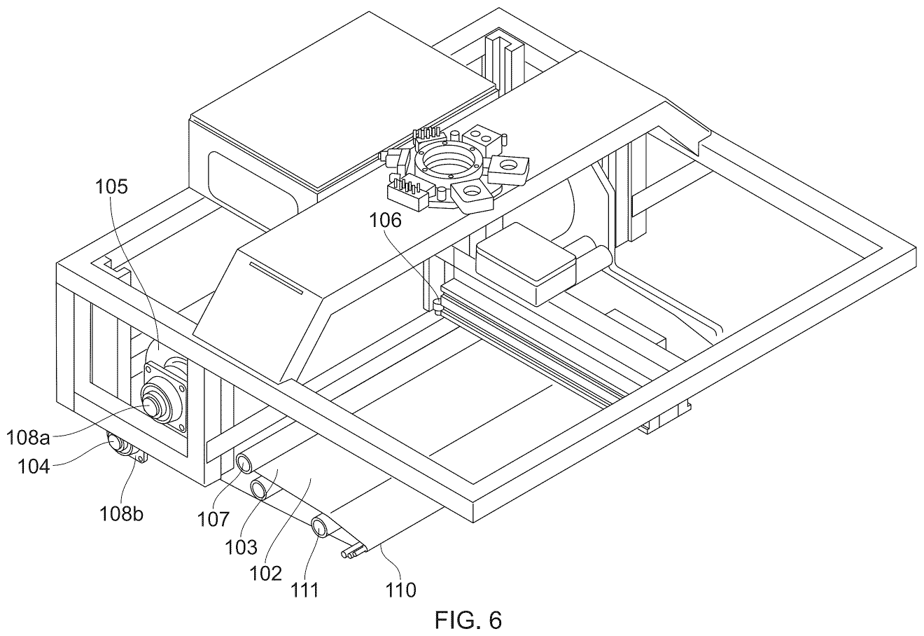

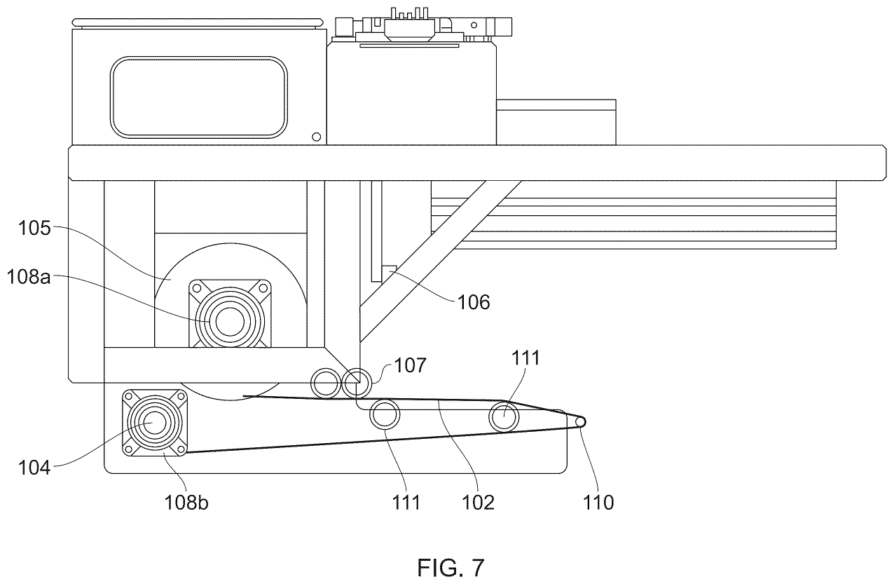

FIGS. 6 and 7 show the system with the material handling stage 101 removed. Where the flexible material 1101 is to be stored for a prolonged period, it is loaded into the material support and storage stage or spool 1203 as previously described.

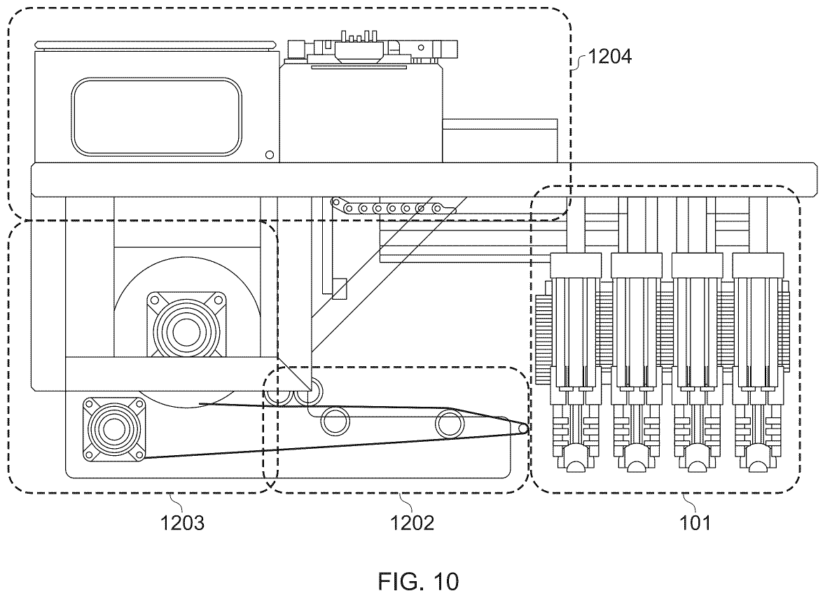

Referring to FIG. 10, once loaded, the support and storage stage or spool 1203 may be detached and removed for storage or transport. The flexible material rolling machine may then be loaded with either an empty material support and storage stage 1203, or one that has previously been loaded with a flexible material and continue to be used in the manufacturing process.

As there is reduced interaction with the flexible sheets of material during the pick/store/place process, this significantly reduces the potential for material damage and once loaded on a roller ensures long term storage in a stable environment.

The invention has been described by way of examples only and it will be appreciated that variation may be made to the aforementioned embodiment without departing from the scope of protection as defined by the claims.

For example, although reference has been made to carbon fibre, it is appreciated that the flexible material rolling machine may be used to roll other flexible or woven material including, glass fibre, Kevlar (RTM) and other technical textiles and fabrics.

### Parts List

101 Material handling stage
102 Material conveyor
103 Flexible support layer
104 Backing support material storage roller
105 First material storage roller
106 Vision stage or imaging system
107 Material control stage
108a First material storage roller controller
108b Backing support material storage roller controller
109 Material stabilisation units
110 Conveyor leading edge
111 Conveyor support system
112 Releasable connectors
113 Releasable connector control mechanism
114 Material handling transfer and control mechanism
115 Controller
401 Pick and place continuous recirculating feed
1101 Flexible material, technical textile, or fabric
1201 Material handling/pick and place stage
1202 Material transfer stage
1203 Material support and storage stage or spool
1204 Machine control stage
1301 Flexible material rolling machine
1302 Preparation surface

1. A flexible material rolling machine comprises a drive means which is operative to drive a first material storage spool or roller and a supply of a flexible support layer which is wound onto the first material storage roller or spool when the drive means is operational; and an area of the flexible support layer receives and supports a sheet of flexible material to be rolled, whereby the sheet of flexible material is sandwiched between the flexible support layer, on which it is supported, and an underside of the flexible support layer that is already wound on the first material storage roller or spool.

2. A flexible material rolling machine according to claim 1 wherein the first storage spool or roller is cylindrical.

3. A flexible material rolling machine according to claim 1 wherein the supply of the flexible support layer is stored on a second roller.

4. A flexible material rolling machine according to claim 3 wherein at least one drive means is provided for driving the second roller.

5. A flexible material rolling machine according to claim 1 wherein at least one tensioner is provided for varying tension imparted to the flexible support layer.

6. A flexible material rolling machine according to claim 5 wherein the at least one tensioner is a guide around which the flexible support layer is folded.

7. A flexible material rolling machine according to claim 1 includes pinch rollers for controlling tension or position of the flexible material during loading and unloading.

8. A flexible material rolling machine according to claim 1 includes a grip roller which is operative to maintain a consistent tension across a width of the flexible material during loading and unloading.

9. A flexible material rolling machine according to claim 1 wherein an air entrainment means is used to displace the flexible material.

10. A flexible material rolling machine according to claim 1 wherein one or more debulking rollers are deployed during loading and unloading of the flexible material in order to remove air and reduce occupied volume of the material.

11. A flexible material rolling machine according to claim 1 wherein an imaging system is used for monitoring a characteristic of the flexible material.

12. A flexible material rolling machine according to claim 11 wherein the imaging system is used for material position monitoring.

13. A flexible material rolling machine according to claim 1 wherein a controller is operative to control pick/place elements.

14. A flexible material rolling machine according to claim 1 wherein the, or each, storage spool or roller, on which wound material is stored, is removable to enable remote storage of the flexible material.

15. A flexible material rolling machine according to claim 1 wherein the flexible material includes carbon fibre.

16. A flexible material rolling machine according to claim 1 includes at least one passive leading-edge or active leading-edge stage sensor which provides a feedback signals for controlling at least the speed of the drive means during a pick/place step.

17. A flexible material rolling machine according to claim 5 wherein the at least one tensioner grips an edge of the material.

18. A flexible material rolling machine according to claim 1 wherein the flexible support layer comprises a chain of small rigid sections of material.

19. A flexible material rolling machine according to claim 1 wherein a grip roller or edge gripping mechanism is operative to maintain tension within the flexible material during loading and unloading.

20. (canceled)

21. A flexible material rolling machine according to claim 1 wherein a vacuum system is used to control the flexible material during loading and unloading.

22. A flexible material rolling machine according to claim 1 wherein an imaging system is used for path correction.

23. A flexible material rolling machine according to claim 1 includes a means for cutting the flexible material.

24. A method of operating a flexible material rolling machine according to claim 1 comprising the steps of: operating a drive means to drive a first storage spool or roller; operating a second storage spool or roller which has a flexible support layer wound thereon, unwinding the flexible support layer from the second storage spool or roller and winding the flexible layer onto the first storage spool or roller when the drive means is operational; deploying an area of the flexible support layer and supporting a sheet of flexible material to be rolled, on a support surface thereof and sandwiching the sheet of flexible material between an underside of the flexible support layer, that is already wound on the first storage spool or roller and the support surface of the flexible support layer.

25-26. (canceled)
